(19) United States
(12) Patent Application Publication
(10) Pub. No.: US 2010/0205822 A1
(43) Pub. Date: Aug. 19, 2010

(54) METHOD OF DRYING A TUBULAR STRING TO PREVENT BEDWRAP CORROSION

(76) Inventor: Bruce A. Munden, Galveston, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/623,769

(22) Filed: Nov. 23, 2009

Related U.S. Application Data
(63) Continuation-in-part of application No. 12/388,138, filed on Feb. 18, 2009.
Application No. 12/388,138 is a continuation-in-part of application No. 12/388,166, filed on Feb. 18, 2009.

(51) Int. Cl. F26B 7/00

(52) U.S. Cl. 34/437

(57) ABSTRACT

Embodiments of the present invention generally relate to a method of drying a tubular string to prevent bedwrap corrosion. In one embodiment, a method of drying a tubular string includes deploying a first bypass pig in the tubular string. The method further includes injecting propellant behind the first bypass pig, thereby driving the first bypass pig through the tubular string. A portion of the propellant bypasses the first bypass pig, thereby drying an inner surface of the tubular string.

### CROSS-REFERENCE TO RELATED APPLICATIONS

This application is a continuation-in-part of U.S. patent application Ser. No. 12/388,138 (Atty. Dock. No. TUBE/0002), filed Feb. 18, 2009, and U.S. patent application Ser. No. 12/388,166 (Atty. Dock. No. TUBE/0003), filed Feb. 18, 2009, both of which are herein incorporated by reference in their entireties.

### BACKGROUND OF THE INVENTION

1. Field of the Invention

Embodiments of the present invention generally relate to a method of drying a tubular string to prevent bedwrap corrosion.

2. Description of the Related Art

Coiled tubing (CT) strings are utilized to perform a variety of functions inside oil, gas and water wells, such as pumping fluid through the CT string from the ground surface at the wellhead to the bottom of the well. Once the desired work on the well is completed, the CT string is removed from the well and recoiled onto a spool. Due to the nature of the CT string often being many thousands of feet in length and a small interior diameter, residual fluid & contaminants remain in the CT string in very small quantities.

Conventional methods of drying CT strings include blowing large volumes of high pressure nitrogen through the CT string in an attempt to force any remaining corrosive liquids out of the coil of tubing. Even when these methods are used in combination with conventional pipeline pigs, small amounts of corrosive fluids & residue remain in the coil and continue to corrode or rot the tubing at the 6 o'clock position while the coil is in storage or waiting for the next use. There is currently no known method by which all corrosive fluids & residue can be removed from such CT strings.

### SUMMARY OF THE INVENTION

Embodiments of the present invention generally relate to a method of drying a tubular string to prevent bedwrap corrosion. In one embodiment, a method of drying a tubular string includes deploying a first bypass pig in the tubular string. The method further includes injecting propellant behind the first bypass pig, thereby driving the first bypass pig through the tubular string. A portion of the propellant bypasses the first bypass pig, thereby drying an inner surface of the tubular string.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates pigtrain deployed in a coiled tubing string, according to one embodiment of the present invention. FIG. 1A is an enlargement of a portion of FIG. 1.

FIG. 2A is a longitudinal cross-section of a trail bypass pig of the pigtrain. FIG. 2B is a radial cross-section of the trail bypass pig.

FIG. 3A is a longitudinal cross-section of a lead bypass pig of the pigtrain. FIG. 3B is an end view of the lead bypass pig.

### DETAILED DESCRIPTION

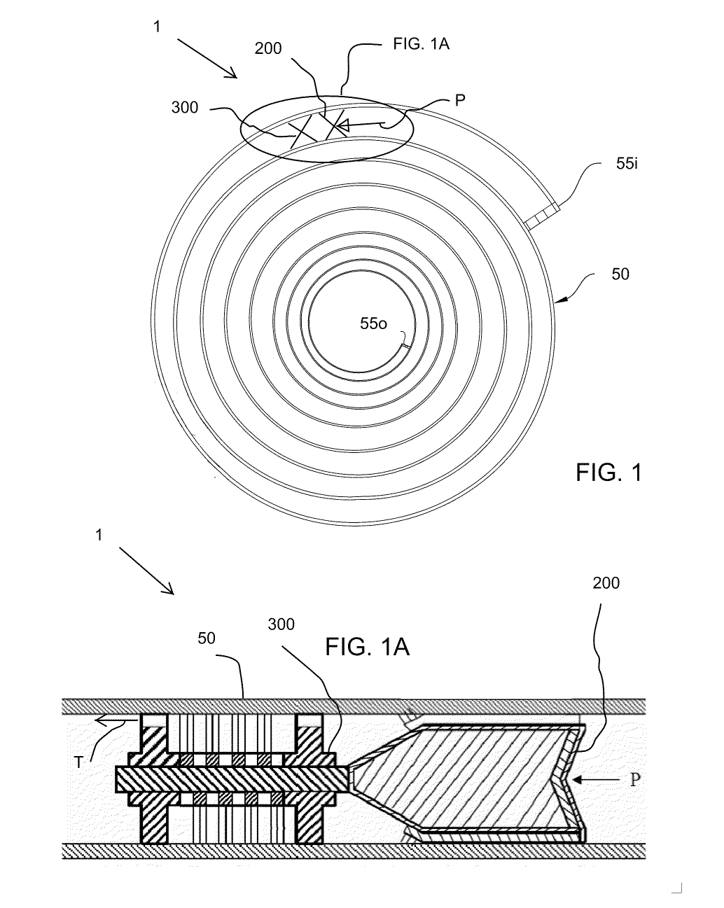

FIG. 1 illustrates a pigtrain 1 deployed in a coiled tubing (CT) string 50, according to one embodiment of the present invention. FIG. 1A is an enlargement of a portion of FIG. 1. Alternatively, the pigtrain 1 may be deployed in other tubular strings, such as a pipeline or reeled pipe. The pigtrain 1 may include one or more lead pigs 300 and a trail pig 200. The lead and trail designations and inlet and outlet designations may be arbitrary as the pigtrain 1 may be bidirectional and/or the inlet 55i and outlet 55o may be reversed. As discussed below, the pigtrain 1 may be deployed to dry the CT string 50. As discussed above, the CT string 50 may have residual liquid from being deployed into a wellbore. Alternatively, it may be desirable to dry the CT string 50 after manufacture on the manufacturer's production reel or after use in a pipeline.

In preparing the CT string 50 for deployment of the pigtrain 1, an inlet 55i and outlet 55o of the CT string 50 may be located at or near ground level to allow for easier access. A clamp (not shown) may be secured to each of the inlet 55i and outlet 55o. Each clamp may have a flange or threaded coupling to receive corresponding flanges or threaded couplings of a pig launcher (not shown) and a pig receiver (not shown). The launcher and receiver designations may be arbitrary as the pigtrain 1 may be bidirectional. Each of the launcher and receiver may include a pipe and a bumper. The pipe may include a propellant port and a door at an end thereof for insertion or removal of the pig. The pipe may have an increased diameter relative to the CT string 50 and each of the launcher and receiver may further include a reducer connecting the pipe to the CT string 50 to facilitate ease of insertion or removal of the pigtrain 1.

The lead 300 and trail 200 pigs may be loaded into the launcher followed by the bumper. The door of the launcher may be closed and a propellant supply hose may be connected to the propellant port. The receiver bumper may also be loaded into the receiver pipe, the door closed, and a vent hose connected to the propellant supply.

Propellant P may be injected into the launcher to drive the pigtrain 1 through the CT string 50. The propellant P may be a fluid, such as compressed gas, such as dry air or nitrogen. When the pigtrain 1 reaches the receiver connected to the outlet 55o, the lead pig 300 may be stopped by the receiver bumper. At this point, the propellant P may be sampled and the moisture content measured and compared to a predetermined level to determine if the CT string 50 is dry after one pass or if the pigtrain 1 needs be driven back through the CT string 50 until the pigtrain 1 reaches the launcher bumper. This back and forth movement of the pigtrain 1 may be repeated until an inner surface of the coiled tubing 50 is sufficiently clean and/or dry. Alternatively, the pigtrain 1 may be transported back to the launcher and redeployed using the launcher. Alternatively, the pigtrain may be inverted and deployed using the receiver.

Alternatively, the bumpers may be omitted. Alternatively, the pig launcher and receiver as illustrated in FIGS. 1 and 9-11 of U.S. Pat. No. 5,230,842, which is herein incorporated by reference in its entirety, may be used to launch and receive the pigtrain 1. Alternatively, the pigtrain 1 may be deployed into the CT string 50 without using a launcher and receiver. Additionally, a second pigtrain (not shown) may be deployed in series with the pigtrain 1. The second pigtrain may include a lead bypass pig and a trail bypass pig. The second pigtrain may be deployed adjacent to the pigtrain 1 such that the second pigtrain utilizes the lead or trail pig of the pigtrain 1 as one of its members. Alternatively, the second pigtrain may be deployed a distance from the pigtrain 1 such that a cushion of propellant exists between the pigtrains. In this alternative, the second pigtrain may have its own lead pig and trail pig.

Alternatively, the pigtrain 1 may be used as part of a multi-cycle regimen for treating, such as cleaning and/or coating, the CT string 50. One regimen may include a first cycle including deploying a pigtrain discussed and illustrated in the '166 application (incorporated above), back and forth through the CT string 50 one or more times with a first working fluid, such as detergent, and a second cycle with a different second working fluid, such as water or neutralizer.

The '166 pigtrain may include a lead pig, a bypass pig, and a trail pig. The bypass pig may be either of the pigs 200, 300 and the lead and trail pigs may be similar to either of the pigs 200, 300 except for omission of the bypass. When the '166 pigtrain is initially deployed in the CT string 50 from the launcher, the bypass pig may be in a first position closer to the lead pig than the trail pig, such as proximate to or abutting the lead pig. As the '166 pigtrain proceeds through the CT string 50, a portion of the working fluid may flow through the bypasses, thereby forcing the bypass pig to gradually move from the first position to a second position closer to the trail pig than the lead pig, such as proximate to or abutting the trail pig, relative to the movement of the '166 pigtrain. The relative movement of the bypass pig may agitate the working fluid and/or liquid residue as the '166 pigtrain proceeds through the CT string 50, thereby facilitating the removal of debris from the inner surface of the CT string.

The regimen may be a multi-cycle cleaning regimen for cleaning and then sealing the CT string 50 with a pressurized gage pressure or zero gage pressure atmosphere, such as dry air or nitrogen, inside the coiled tubing 50 to prevent corrosion thereof during storage. The '166 pigtrain may be deployed with the detergent, such as a surfactant or basic solution, for a degreasing cycle. The cycle may be repeated until a white-metal or near white-metal finish, such as NACE number one or two, is achieved. The '166 pigtrain may then be deployed with water for a rinse cycle. The '166 pigtrain may then be deployed with the corrosion inhibitor. The pigtrain 1 may then be deployed with dry air or nitrogen propellant for a drying cycle. A squeegee pig, such as a foam pig, may be deployed with nitrogen or dry air propellant for a blanket cycle. The ends 55i, o may be sealed with the blanket inside the coiled tubing 50 at positive or zero gage pressure and the CT string 50 placed in storage.

Alternatively, the regimen may be a multi-cycle interior coating regimen for the CT string 50. The regimen may include deployment of the '166 pigtrain with the detergent, such as a surfactant or basic solution, for a degreasing cycle. The '166pigtrain may then be deployed with water for a rinse cycle. The '166 pigtrain may then be deployed with another detergent, such as an acidic solution, for descaling. The cycle may be performed until a white-metal or near white-metal finish, such as NACE number one or two, is achieved. The '166 pigtrain may then be deployed with the neutralizer. The pigtrain 1 may then be deployed with dry air or nitrogen propellant for a drying cycle. The '166 pigtrain may then be deployed with the corrosion inhibitor. The coating (not shown) may be applied by injecting liquid coating material, such as a polymer (i.e., epoxy, polyurethane, or polytetrafluoroethylene) between two extruder pigs (not shown) of a pigtrain and propelling the pigtrain using dry air or nitrogen through the CT string 50.

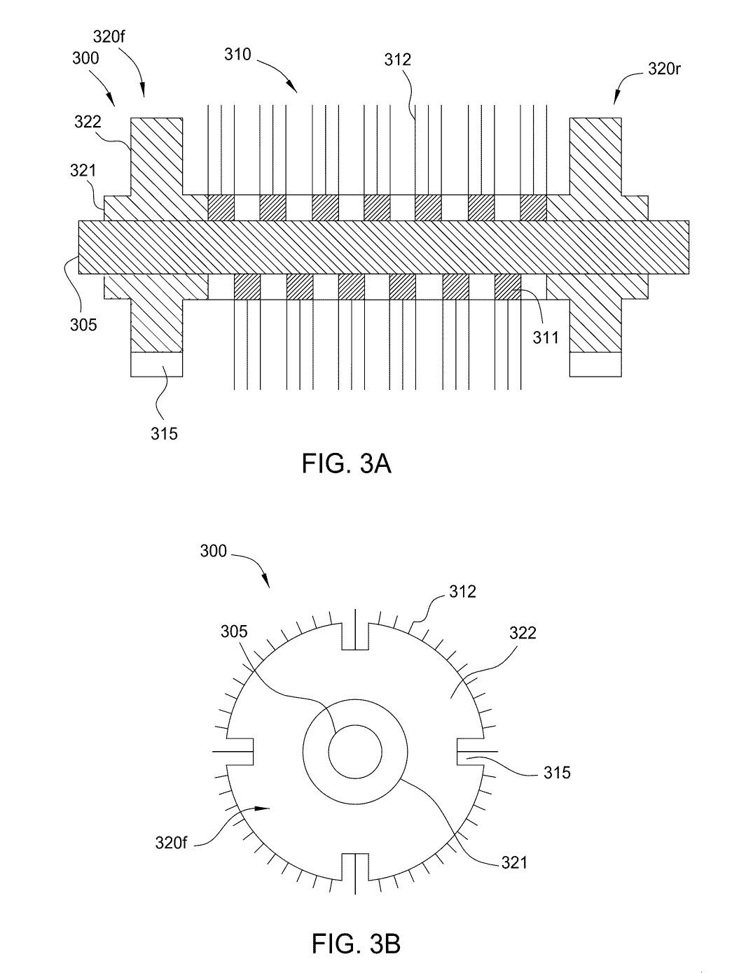

Suitable pipeline extruder pigs are illustrated in FIGS. 3-6 of the '842 patent. The pipeline extruder pigs may be modified for use in coiled tubing or reeled pipe by omitting the intermediate disc members and shortening the base portion of the leading pig and omitting the intermediate disc members and shortening the base portion of the trailing pig. As the extruder pigs progress through the CT string 50, they may apply a uniform thickness coating of the material onto the interior surface of the CT string 50. After a layer of coating material has been applied, the CT string 50 may be subjected to a drying or curing process to insure the coating bonds to the tubing 50. For instance, dry air may be passed through the tubing to dry the coating or the tubing may be subjected to heat to cure the lining material thereby creating a mechanical bond between the coating and the tubing 50. Additional layers may be applied. Each layer may have a thickness of less than 0.0015 inch and, if multi-layer, the aggregate thickness of the coating may be less than 0.004 inch.

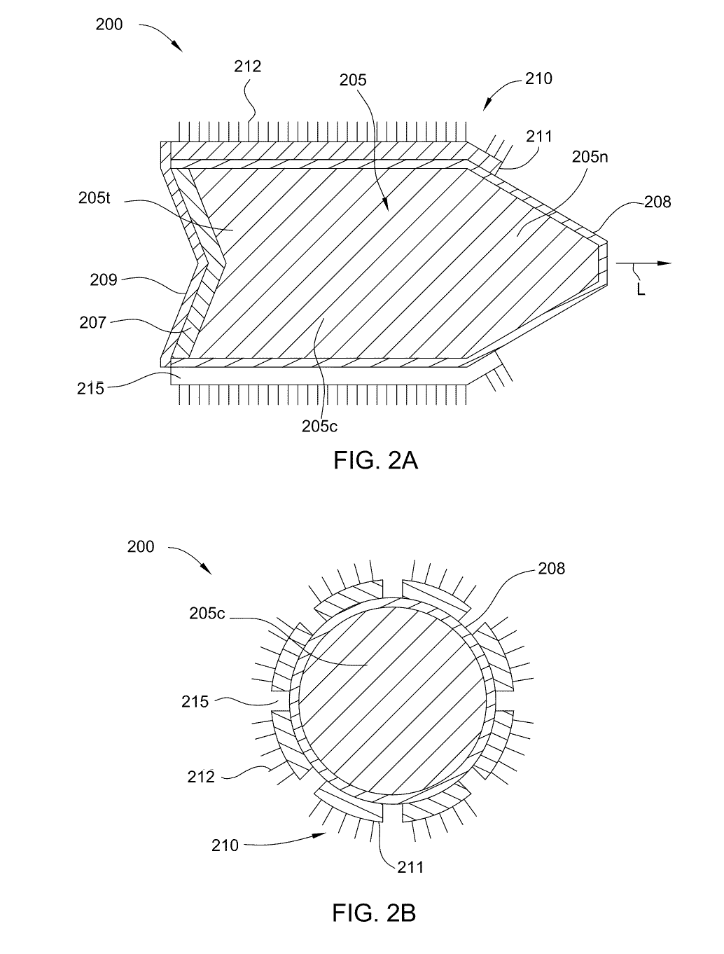

FIG. 2A is a longitudinal cross-section of a trail bypass pig 200 of the pigtrain 1. FIG. 2B is a radial cross-section of the trail bypass pig 200. The pig 200 may include a body 205, a tail plate 207, one or more brushes 210, and a bypass 215. A longitudinal axis L is shown for reference. The body 205 may be made from a flexible material, such as a polymer. The polymer may be foamed polymer, such as polyurethane, or a non-foamed polymer. The body 205 may be bullet-shaped and include a nose portion 205n, a tail portion 205t and a cylindrical portion 205c. The tail portion 205t may be concave or flat. The nose portion 205n may be conical, hemispherical or hemi-ellipsoidal. Alternatively, the nose portion 205n may instead be a second tail portion so that the pig 200 is bidirectional. The tail plate 207 may be bonded to the tail portion 205n during molding of the body 205. The shape of the tail plate 207 may correspond to the tail portion 205t. The tail plate 207 may be made from a (non-foamed) polymer, such as polyurethane.

The brushes 210 may each extend along an outer surface of the body 205. Each brush 210 may include a base 211 and bristles 212 embedded therein along a length and a width thereof. The bristles 212 may be made from a metal or alloy, such as steel, or a polymer. Alternatively, grains of abrasive material, such as sand, glass, diamond dust, or carbide (i.e., silicon or tungsten) may be embedded in the base 211 instead of the bristles 212. Each base 211 may be a strip made from a (non-foamed) polymer, such as polyurethane, ploychloroprene, or polyisoprene. Each base 211 may be a cylindrical segment to conform to the outer surface of the cylindrical portion 205c. Each base 211 may be longitudinally straight. Alternatively, each base 211 may extend longitudinally and tangentially along the body 205 in a helical orientation or a single base 211 may be helically wound along the body 205, thereby rotating the pig as the pig travels longitudinally through a tubular string. This spiral motion may serve to more evenly distribute wear to the brushes 210. Alternatively, scrapers may be used instead of brushes. Alternatively, the brushes may be omitted.

Each brush 210 may extend from the tail plate 207 or portion 205t, along the cylindrical portion 205c, and over a portion of the nose 205n. Each brush 210 may be bonded to the body by an adhesive 208, such as a (non-foamed) polymer, such as polyurethane, ploychloroprene, or polyisoprene. The adhesive 208 may be applied around the cylindrical portion 205c, over the nose 205n, and an outer surface of the tail plate 205t so that the adhesive serves as an overcoat 208 for the body 205 as well as an adhesive for the brushes 210. A tail coat 209 may be applied to the rear surface of the tail plate 207 and the bases 211. The tail coat 209 may be a (non-foamed) polymer, such as polyurethane, ploychloroprene, or polyisoprene. The brushes 210 may be tangentially spaced around the body 205, thereby defining a bypass 215 between each brush 210. The bypasses 215 may each be channels extending along a length of the brushes 210. Relative to the bypasses 215, the brushes 210 may substantially occupy the outer surface of the cylindrical portion 205c, such as more than half, at least two-thirds, at least three-quarters, or at least nine-tenths of the outer surface.

An outer diameter of the cylindrical portion 205c may be equal to, slightly greater than, or slightly less than an inner diameter of the CT string 50. Having interference between the pig 200 and the CT string 50 may ensure tight engagement of the bristles 212 with the inner surface of the CT string 50.

FIG. 3A is a longitudinal cross-section of a bypass pig 300, according to another embodiment of the present invention. FIG. 3B is an end view of the bypass pig 300. The pig 300 may include a mandrel 305, a front seal 320f, a rear seal 320r, a brush 310, and a bypass 315. The mandrel 305 may be a rod having a threaded outer surface and made from a flexible material, such as a polymer. Alternatively, the mandrel 305 may be a threaded tubular capped at each longitudinal end thereof.

The brush 310 may extend along an outer surface of the mandrel 305. The brush 310 may include a base 311 and bristles 312 bonded thereto along a length and width thereof. The base 311 may be a helically wound strip or channel made from a metal or alloy, such as steel. The bristles 312 may be made from a metal or alloy, such as steel, or a polymer. Alternatively, a scraper may be used instead of a brush. Alternatively, the brush may be omitted.

The seals 320f,r may each include a hub portion 321, a disc portion 322, and one or more bypasses 315. The front and rear designations may be arbitrary as the pig 300 may be bidirectional. The seals 320f,r may each be made from a polymer, such as polyurethane, ploychloroprene, or polyisoprene. An inner surface of the hub portion 321 may be threaded corresponding to the threaded outer surface of the mandrel 305. An inner end of each hub portion 321 may abut a respective end of the base 311, thereby retaining the brush 310 on the mandrel 305. The bypasses 315 may each be a channel formed in an outer surface of each of the disc portions 322 and extending longitudinally therethrough. Alternatively, the bypasses may each be a hole formed longitudinally through each of the disc portions 322. The bypasses 315 may be tangentially spaced around each of the disc portions 322. Alternatively, each hub 321 may be a separate member made from a polymer, such as nylon, and bonded to the disc 322. Alternatively, nuts made from a polymer, such as nylon, may be used to straddle the disc portion 322 and the base 311 instead of the hub 321. Alternatively, cups may be used instead of the discs 322. Alternatively, the bypasses 315 of the front seal 320f may be misaligned with the bypasses 315 of the rear seal 320r. Additionally, the hubs or nuts may be bonded to the mandrel after threaded connection.

An outer diameter of each disc portion 322 may be equal to or slightly greater than an inner diameter of the CT string 50 to ensure tight sealing engagement of the discs 322 with the CT string 50. The bristles 312 may radially extend from the base 311 to, or slightly outward past the outer diameter of the disc portions 322 to ensure tight engagement of the bristles 312 with the CT string 50.

Returning to FIGS. 1 and 1A, as the pigtrain 1 travels through the CT string 50, bristles 212, 312 of each pig 200, 300 may drag along an inner surface of the CT string 50. A portion of the propellant P may bypass the pigtrain 1 via the bypasses 215, 315. As the bypassed portion of the propellant P exits the bypasses 215, 315, a fluid (liquid and/or gas) jet T may be created proximately in front of the lead pig 300, thereby facilitating removal of fluid, such as residual liquid, from the inner surface of the CT string 50. A velocity of the fluid jet T may be sufficient to disrupt the boundary layer, thereby churning the fluid. Locating the bypass along an outer portion of the pig 1 advantageously maintains increased (i.e., maximum) local velocity of the jet T at an inner surface of the CT string 50 where the drying is occurring. The bristles 212, 312 may also serve to disrupt and disengage moisture droplets clinging to the CT string inner surface, thereby allowing the jet T to continuously move the moisture ahead of the pigtrain 1 and out of the CT string 50.

A number and length of the pigs 200, 300 may determine the amount of “drag” created by the brushes against the interior wall of the string. The amount of propellant force required to push the pigtrain 1 through the CT string 50 may also determine how much of the propellant P bypasses the pigtrain 1 at the inner surface of the tubing 50 and brush interface, thereby facilitating the removal of fluids ahead of the pigtrain 1 as the pigtrain moves through the CT string 50. Conventional pigs inserted into a CT string and driven with propellant serve to redistribute any residual liquid in the string over a length of the string. Once the propellant is stopped after running conventional pigs, the residual, redistributed fluid simply returns to the 6 o'clock position in the coil bed wraps and forms a corrosive point in the string bed wraps. Due to the nature of the pigs 200, 300 creating a predetermined drag force on the pigtrain 1, at least a portion, such as a substantial portion, of the propellant P bypasses the pigtrain and creates the jet T of propellant P sufficient to move any liquid remaining in the CT string 50 ahead of the pigtrain 1. Once the pigtrain 1 reaches the end of the CT string 50, at least a portion, such as a substantial portion or all, of the remaining liquid has been forced out of the CT string 50 ahead of the pigtrain 1 leaving behind only the dry propellant P used to force the pigtrain 1 through the CT string 50.

Alternatively, only one of the bypass pigs 200, 300 may be deployed to dry the CT string 50 instead of the pigtrain 1. Alternatively, bypass pig 200 may be the lead pig and bypass pig 300 may be the trail pig. Alternatively, the pigtrain 1 may include a plurality of lead pigs 300 and one trail pig 200. Alternatively, the pigtrain 1 may include one lead pig 300 and a plurality of trail pigs 200. Alternatively, the pigtrain 1 may include a plurality of lead pigs 300 and a plurality of trail pigs 200. Alternatively, the pigtrain 1 may include only a plurality of the pigs 300. Alternatively, the pigtrain 1 may include a plurality of the pigs 200.

Alternatively, the bypass 215 may be centrally formed through the body 205 and/or the bypass 315 may be centrally formed through the mandrel 305.

While the foregoing is directed to embodiments of the present invention, other and further embodiments of the invention may be devised without departing from the basic scope thereof, and the scope thereof is determined by the claims that follow.

1. A method of drying a tubular string, comprising:
deploying a first bypass pig in the tubular string; and
injecting propellant behind the first bypass pig, thereby driving the first bypass pig through the tubular string, wherein a portion of the propellant bypasses the first bypass pig, thereby drying an inner surface of the tubular string.

2. The method of claim 1, wherein:
the first bypass pig is deployed with a second bypass pig, thereby forming a first pigtrain, and
the first bypass pig is a trail pig and the second bypass pig is the lead pig, and
the first pigtrain is driven through the tubular string.

3. The method of claim 2, wherein each bypass pig comprises:
a brush operable to engage an inner surface of the tubular string; and
a seal operable to engage an inner surface of the tubular string and having a bypass formed therethrough.

4. The method of claim 3, wherein one of the bypass pigs further comprises a mandrel and the other bypass pig further comprises a foam body.

5. The method of claim 4, wherein the lead pig further comprises the mandrel and the trail pig further comprises the foam body.

6. The method of claim 2, wherein at least one of the pigs comprises:
a cylindrical body;
two or more brushes disposed along an outer surface of the body, the brushes operable to engage and dry an inner surface of the tubular string; and
a bypass formed between the brushes.

7. The method of claim 2, wherein at least one of the pigs comprises:
a cylindrical body;
a brush wound around and along an outer surface of the body, the brush operable to engage and dry an inner surface of the tubular string; and
a bypass formed between windings of the brush.

8. The method of claim 2, wherein at least one of the pigs comprises:
a mandrel;
a seal coupled to the mandrel, operable to engage an inner surface of the tubular string, and having a bypass formed longitudinally therethrough; and
a brush disposed along the mandrel, the brush operable to engage and dry an inner surface of the tubular string.

9. The method of claim 2, further comprising:
deploying a second pigtrain in series with the first pigtrain; and
wherein injecting the propellant drives the pigtrains through the tubular string.

10. The method of claim 2, wherein the first pigtrain further comprises a third bypass pig.

11. The method of claim 1, further comprising:
measuring a moisture content of the propellant; and
re-driving the first bypass pig through the tubular string until the moisture content is less than or equal to a predetermined amount.

12. The method of claim 1, wherein the tubular string is coiled tubing or reeled pipe.

13. The method of claim 1, further comprising:
injecting nitrogen or dry air into the tubular string; and
sealing ends of the tubular string.

14. The method of claim 1, further comprising:
injecting working fluid between a lead pig and a trail pig of a pigtrain, wherein a second bypass pig of the second pigtrain is in a first position between the lead pig and trail pig and closer to the lead pig; and
injecting propellant behind the trail pig, thereby driving the second pigtrain through the tubular string, wherein the second bypass pig gradually moves from the first position to a second position closer to the trail pig, thereby agitating the working fluid.

15. The method of claim 14, wherein the pigtrain is cycled through the tubular string until a white-metal or near white-metal finish is achieved.

16. The method of claim 1, wherein the propellant portion is bypassed along an outer portion of the first bypass pig.

17. The method of claim 1, wherein the propellant is dry air or nitrogen.
